(19) United States
(12) Patent Application Publication
(10) Pub. No.: US 2013/0170726 A1
(43) Pub. Date: Jul. 4, 2013

(54) REGISTRATION OF SCANNED OBJECTS OBTAINED FROM DIFFERENT ORIENTATIONS

(71) Applicants: Arie E. Kaufman, Plainveiw, NY (US); Xianfeng David Gu, Plainview, NY (US); Wei Zeng, Miami, FL (US); Joseph Marino, Port Jefferson Station, NY (US); Krishna Chaitanya Gurijala, Andhra Pradesh (IN)

(72) Inventors: Arie E. Kaufman, Plainveiw, NY (US); Xianfeng David Gu, Plainview, NY (US); Wei Zeng, Miami, FL (US); Joseph Marino, Port Jefferson Station, NY (US); Krishna Chaitanya Gurijala, Andhra Pradesh (IN)

(73) Assignee: The Research Foundation of State University of New York, Albany, NY (US)

(21) Appl. No.: 13/822,515

(22) PCT Filed: Sep. 26, 2011
(86) PCT No.: PCT/US11/53300

§ 371 Date: Mar. 12, 2013

Related U.S. Application Data
(60) Provisional application No. 61/386,134, filed on Sep. 24, 2010.
(60) Provisional application No. 61/539,118, filed on Sep. 26, 2011.
(60) Provisional application No. 61/539,122, filed on Sep. 26, 2011.

(51) Int. Cl. G06T 7/00

(52) U.S. Cl. CPC G06T 7/0012
USPC 382/131

(57) ABSTRACT

Disclosed is a method for registration of scans of an object, such as a biological organ, by obtaining scans of the object that includes a first scan obtained with the object in a first position and a second scan obtained with the object in a second position different from the first position, extracting landmarks within each of the scans, flattening each of the scans, detecting feature points of each of the flattened scans, matching corresponding feature points of each of the flattened scans, performing a harmonic map registration using the matched corresponding feature points and displaying the registered scans.

### PRIORITY

This application claims priority to U.S. Provisional Application No. 61/386,134, filed Sep. 24, 2010, to U.S. Provisional Application No. 61/539,118, filed Sep. 26, 2011, and to U.S. Provisional Application No. 61/539,122, filed Sep. 26, 2011, the contents of which are incorporated herein by reference.

### GOVERNMENT RIGHTS

This invention was made with government support under grant number EB007530 awarded by the National Institute of Health and grant number IIS0916235 awarded by the National Science Foundation. The government has certain rights in the invention.

### BACKGROUND OF THE INVENTION

1. Field of the Invention

The present invention relates generally to registration of scanned objects and, more particularly, to a method and apparatus for three-dimensional (3D) mapping of different scans of an object for visualization purposes.

2. Description of the Related Art

Virtual Colonoscopy (VC) is a non-invasive screening method to explore a colon surface for anomalies, similar to optical colonoscopy performed by a gastroenterologist. For example, see Hong, et al., Virtual Voyage: Interactive Navigation in the Human Colon, Proc. of SIGGRAPH, pp. 27-34 (1997). Conventional colon-flattening methods deform a 3D mesh model of the extracted colon to a flat two-dimensional (2D) plane. For example, a method based on cylindrical projections of colon segments is proposed by Bartoli, et al. Virtual Colon Flattening, Proc. of VisSym Joint Eurographics, IEEE TCVG Symposium on Visualization, pp. 127-136 (2001). Also see U.S. Pat. No. 7,640,050 to Glenn et al., the contents of which are incorporated herein by reference, which proposes analyzing and displaying images rendered from data sets resulting from a scan of a patient. In Glenn, the displayed images include both 2D and 3D views of selected portions of a patient's anatomy, including a tubular structure such as a colon.

Conventional methods include a mass-spring unfolding, as proposed by Umemoto, et al., Extraction of Taeniae Coli From CT Volumes for Assisting Virtual Colonoscopy, Proc. of SPIE Medical Imaging, pp. 6916-69160D (2008), and reconstruction of a virtual endoscopic view using landmarks in the human colon viz. the haustral folds (colonic folds) and taeniae coli as landmarks, as proposed in Chowdhury, et al., Detection of Anatomical Landmarks in Human Colon from Computed Tomographic Colonography Images, Proc. International Conference on Pattern Recognition (2008).

U.S. Pat. No. 6,331,116 to Kaufman et al., the contents of which are incorporated herein by reference, teaches a technique for operator view adjustment while traveling along a flight path using three-dimensional imaging of objects such as organs. The '116 patent allows for view adjustment onto a particular portion of an image that is of interest, for example a polyp or cyst, in a real time manner. U.S. Pat. No. 6,928,314 to Johnson et al., the contents of which are incorporated herein by reference, suggests a medical imaging device such as a Computed Tomography (CT) scanner that receives a first image data set representing a portion of the colon in a prone position and a second image data set representing a portion of the colon in a supine position, at a series of viewpoints. At each of the viewpoints, an image is generated of the colon in the prone and supine positions. The prone and supine images of the colon are simultaneously displayed on a screen display in a dual view mode.

In U.S. Pat. No. 7,570,986 to Huang et al., the contents of which are incorporated herein by reference, VC is utilized to detect surface features by providing a 3D construction of a computed tomography colonography surface, creating a path along the taeniae coli from the proximal ascending colon to the distal descending colon on the colonography surface, forming an indexed computed tomography colonography surface using the created path, and registering supine and prone scans of the computed tomography colonography surface using the indexed computed tomography colonography surface. Huang also suggests navigating the internal surface of the computed tomography colonography using the indexed computed tomography colonography surface.

U.S. Pat. No. 5,937,083 to Ostuni, the contents of which are incorporated herein by reference, provides an automated volume registration process based on intensity gradients to register under conditions of unrelated intervolume voxel intensities, significant object displacements or missing data, to allow a user to visualize registration convergence and illustrate sources of registration errors.

U.S. Pat. No. 6,820,032 to Wenzel et al., the contents of which are incorporated herein by reference, suggests scanning for an object within a region using a conformal scanning scheme. In Wenzel, characteristic geometry of a region is determined, a conformal scanning curve is generated based on characteristic geometry of the region by performing a conformal mapping between the characteristic geometry and a first scanning curve to generate the conformal scanning curve, i.e. mapping points of the first scanning curve to the characteristic geometry of the region, and the region is scanned using the conformal scanning curve. These measurements of the region produce data indicative of one or more characteristics of the object.

U.S. Patent Publ. No. 2005/0169507 A1 to Kreeger et al., the contents of which are incorporated herein by reference, suggests a method for generating a 3D image of an organ using a volume visualization technique and exploring the image using a guided navigation system to allow the operator to travel along a flight path and adjust the view to a particular portion of the image of interest in order, for example, to identify polyps, cysts or other abnormal features in the visualized organ. In Kreeger imaging data sets are acquired using 2D scans of the object in both a supine and prone orientation, and correspondence between the respective data sets is determined to permit jumping from one visualization orientation to the other while remaining at the same virtual location within the organ.

In addition, International Publication WO 03/046811 and U.S. Pat. No. 7,372,988 to Yoakum-Stover, et al., the contents of which are incorporated herein by reference, discloses a system and method for registration of scanning data acquired by a scanner and taking multiple images from different positions around a patient who is being scanned. In Yoakum-Stover, a 3D visualization image of an object such as an organ is generated using volume visualization techniques and the image is explored using a guided navigation system that allows the operator to travel along a flight path and to adjust the view to a particular portion of the image of interest in order, for example, to identify polyps, cysts or other abnormal features in the visualized organ. In Yoakum-Stover the imaging data sets are acquired using conventional 2D scans of the object in both a supine and prone orientation, and correspondence between the respective data sets is determined to permit jumping from one visualization orientation to the other while remaining at the same virtual location within the organ. Such conventional methods require a preprocessing step that extracts organ surface details from the image sequence utilizing a triangular mesh model or similar technique.

However, such conventional systems do not allow for quick and immediate checking of an exact same area of a second scan when an anomaly is detected in an area of a first scan. In addition, because shape characteristics are of utmost importance when searching for colon abnormalities, the present invention utilizes conformal geometry to flatten each of the first and second scans following landmark extraction in each scan, thereby providing a system and method for performing registration between surface models of an organ extracted from radiological image sequences acquired with the patient in different positions.

### SUMMARY OF THE INVENTION

The disclosed method overcomes the above shortcomings by providing a one-to-one registration between a plurality of extracted surfaces of an organ or other item of interest, with the registration performed of an entire organ surface, and providing a resultant mapping that allows precise co-location of points on corresponding surfaces, thereby presenting unique abilities for viewing data correlations.

The present invention provides a method for registration of scans obtained from an object, including obtaining a plurality of scans of the object that include a first scan obtained with the object in a first position and a second scan obtained with the object in a second position different from the first position, extracting features within each of the plurality of scans, mapping each of the plurality of scans to a canonical shape, and registering the plurality of scans by matching corresponding features on corresponding canonical shapes.

The present invention also provides an improved virtual colonoscopy and, more particularly, to a method and apparatus for 3D mapping of an organ for improved anomaly detection, for example polyp detection, by performing multiple scans of the organ, extracting landmark features from each scan, registering each scan using rectangular shape conformal mapping, detecting feature points of each scan, matching common features between each of the scans, and creating a harmonic map registration that allows for jumping from one area in a first scan to an identical area in the other scan to improve comparison between scans and provide improved confirmation of anomaly detection.

Further still, the present invention provides a system for visualization of an object that includes a scanner associated with a memory for storing scans obtained by the scanner, a processor and a display, with the scanner obtaining a plurality of scans of an object including a first scan obtained with the object in a first position and a second scan obtained with the object in a second position different from the first position, and the plurality of scans are stored in the memory, with the processer extracting landmarks within each of the plurality of scans, flattening each of the plurality of scans, detecting feature points of each of the plurality of flattened scans, matching corresponding feature points of each of the plurality of flattened scans, performing a harmonic map registration using the matched corresponding feature points, and displaying the registered scans on the display.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIGS. 1(a)-(b) are correlated endoluminal views obtained from supine and prone scans, respectively;

FIGS. 2-3 are flowcharts of processes of preferred embodiments of the present invention;

FIGS. 4(a)-(b) show flexures used to slice each of mapped supine and prone colons, respectively; and

FIGS. 5(a)-(d) are visual verifications obtained from the mapped supine and prone colons.

### DETAILED DESCRIPTION OF THE PREFERRED EMBODIMENTS

The following detailed description of the preferred embodiments will be made with reference to the accompanying drawings. In the description provided herein, explanation of related functions or constructions known in the art are omitted for the sake of clarity in understanding while avoiding obscuring the concept with unnecessary detail.

In a preferred embodiment, a virtual flattening technique is provided for improved colon surface viewing following mapping of the entire colon from the three-dimensional (3D) domain to a two-dimensional (2D) rectangular domain, to preserve local shapes and acquire corresponding view points of each of a plurality of scans performed when a patient is placed in different positions. A one-to-one and onto, i.e. diffeomorphism or surjective, mapping is performed between two flattened meshes to provide landmark correlation.

Flattened colons have a variety of uses in a Virtual Colonoscopy (VC) system, and flattened meshes are used to encode geometric details such as curvature, with normals for each vertex of the flattened mesh being appropriated from the original 3D colon mesh model. For each face, its normal is first computed as the vector perpendicular to the plane in which the face lies. Then, each vertex normal is calculated as the weighted linear combination of the normals of the neighboring faces, where the face areas are used as weights. Two general categories for use of the flattened meshes in a VC system are provided, with volume rendering being used to provide a view similar to an endoluminal view and, in another preferred embodiment, flattened meshes being used to assist in navigation, visualization and analysis through the 3D colon view.

In regards to generating 2D views, the flattened colon can be used alone to provide the user with an overview of the entire colon structure, ensuring that all areas are examined and that no regions are missed due to folds or other structural obstructions. Because the flattened colon is in fact a mesh surface, a conventional polygonal rendering method can be used to visualize the colon. See Haker, et al., Non-distorting Flattening Maps and the 3-D Visualization of Colon CT Images, IEEE Trans. on Med. Imag. 19(7), pp. 665-670 (2000), regarding use of conformal geometry and harmonic analysis to construct a flattening map of a colon surface derived from volumetric Computed Tomography (CT) data. Rendering the conventional mesh surface is inadequate since only a rectangle without any structure would be displayed. Therefore, per-vertex normal values derived from an original 3D colon mesh are applied to the vertices of the flattened mesh and rendering with simulated interaction between light and surface normals provides a sense of the structure of the colon surface.

Display of the surface structure of the flattened mesh is obtained by rendering with normals that are calculated on the original mesh surface rather than from the flattened mesh, with all normals in the same direction. Other properties, such as curvature and color at each vertex, are rendered by encoding of values with interpolation at render time applying the correct curvature/colors across an entire colon surface.

However, these methods of polygonal rendering do not present a user with a display of an image of the same quality and look available from the endoluminal view of a VC system. In an endoluminal view, imagery is generated by volume rendering through the original CT data using a volumetric ray-casting algorithm. To provide the same look and feel in rendered 2D flattened colons, rendering from the 2D surface is mapped to the 3D volume, allowing for presentation to the user of a volume rendered image on the 2D flattened mesh. For each pixel in the 2D image, a starting position for the ray-casting algorithm is given as the corresponding position in the original 3D model, with respect to the local coordinates of the CT volume. Rays are then cast from the local coordinate points through the colon volume, using an appropriate transfer function to generate the desired image. Ray casting is the most popular volume rendering technique and can be readily accelerated on commodity graphics hardware, see, e.g. Smelyanskiy, et al., Mapping High-Fidelity Volume Rendering for Medical Imaging to CPU, GPU and Many-Core Architectures, IEEE Trans. on Visualization and Computer Graphics 15(6), pp. 1563-1570 (2009).

To obtain the direction of the rays, a view position must be obtained for each point. Considering the long, twisty, tubular structure of the colon, a single viewpoint for the entire structure is not feasible. Therefore, a flattened colon is created by slicing the colon open along an axis from cecum to rectum, with each row of the image being equivalent to a loop on the colon surface. By averaging the 3D positions across an image row, an estimated viewpoint is generated that is in the center of that row of pixels. The viewpoints are then generated along an entire mesh of the colon at a resolution equivalent to a desired final rendered image. These viewpoints are then used to obtain the direction vectors inside the volume-rendering algorithm, and the viewpoints are combined through the entire colon to create a flattened centerline. The flattened centerline differs from a conventional 3D skeletal centerline extracted for automatic VC navigation, also referred to as skeleton, see, e.g. Bitter, et al., Penalized-Distance Volumetric Skeleton Algorithm, IEEE Trans. on Visualization and Computer Graphics. 7(3), pp. 195-206 (2001), and U.S. Publ. No 2008/0069419 A1 to Farag et al., the disclosure of which is incorporated herein by reference.

The flattened centerline of this embodiment approximates the skeleton, but is more suitable for working with the flattened mesh. Utilizing the conformal flattening method of Hong et al., as described above, allows for periodic mapping in the 2D domain, and thus a rectangular final mesh and image can be generated, allowing for a much cleaner view without ragged edges. See, Hong, et al., Conformal Virtual Colon Flattening, Proc. of ACM Symposium on Solid and Physical Modeling, pp. 85-93 (2006).

Display of the flattened colons is provided with a registration between two flattened colons that are registered in a one-to-one and onto, i.e. surjective, manner. In such embodiment, the two flattened colons are preferably displayed in a same size, with a pixel in a first rendered flattened colon directly corresponding to a same pixel in another, second, flattened colon, thereby allowing observing of a region in one colon, followed by immediately available observation of the corresponding region in the other colon.

In regards to integration for 3D navigation, the flattened colons assist in guiding 3D navigation by providing a general map, from which the user can select a point (p) on the flattened image, with an endoluminal viewpoint generated to display the same region. To generate this view, a 3D viewpoint in the endoluminal view is required, as well as the three viewing vectors for camera orientation. This further embodiment provides, in addition to the volume rendered structural colon image, a hidden image containing a first intersection point of the view ray and the colon wall. Selection of a pixel for a point to view on the volume rendered image maps the selected pixel to the same pixel in the position image at point p, which is encoded at a position (x, y, z) in the 3D colon volume at which the view is to be directed.

The viewpoint can be identified at point p on a flattened centerline for a row containing the selected pixel. If a viewpoint on the skeleton is desired, the closest point on the skeleton to the flattened centerline point can be used, with the viewpoint being taken as the optical center of the camera, o. The two neighboring points on the flattened centerline (or skeleton) are referred to as c₀ and c₁, respectively. If desired, several points to the left and right could be averaged to provide a smoother version of the axis. Using the four such viewpoints, three view vectors are created using Equations 1-3:

$$\begin{matrix}{v}_{0} = \frac{p - o}{\vert p - o \vert} , & ( 1 ) \\ {v}_{1} = \frac{{c}_{1} - {c}_{0}}{\vert {c}_{1} - {c}_{0} \vert} , & ( 2 ) \\ {v}_{2} = {v}_{0} \times {v}_{1} , & ( 3 )\end{matrix}$$

where a complete view frame is given as {o; v₀, v₁, v₂}, with vector v₀ being a view vector formed by looking at the point of interest; vector v₁ being a ground vector formed along the flattened centerline; and vector v₂ being an up vector taken as a cross product of v₀ and v₁.

Flattened views can also be useful if a one-to-one and onto mapping is formed between colon surfaces extracted from two scans. Such a mapping allows for the immediate identification in one scan of the corresponding location from the other scan, which can also be used for obtaining corresponding endoluminal viewpoints, as described above.

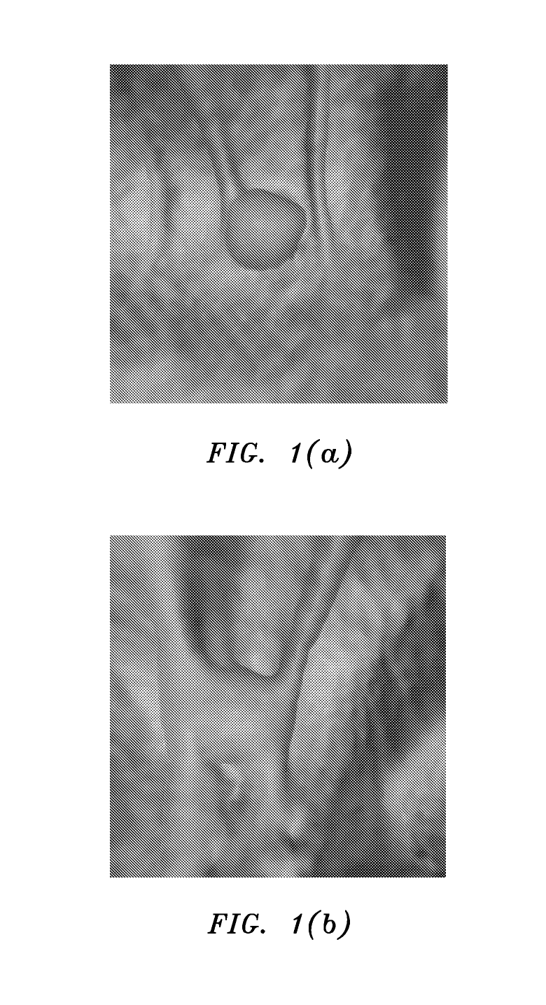

Given a viewpoint oₛ on the flattened centerline in the supine scan, the corresponding viewpoint oₚ in the prone scan can be identified and vice versa. For the supine view, the view vector and up vector intersection points can be identified as s₀ and s₁. The corresponding points on the flattened prone colon can be then be identified as p₀ and p₁. Given these points based on the supine view frame, the three view vectors for the corresponding prone view can be created using Equations 4-6:

$$\begin{matrix}{v}_{p 1} = \frac{{p}_{0} - {o}_{p}}{\vert {p}_{0} - {o}_{p} \vert} , & ( 4 ) \\ {v}_{p 0} = \frac{( {p}_{1} - {o}_{p} ) \times {v}_{p 1}}{\vert ( {p}_{1} - {o}_{p} ) \times {v}_{p 1} \vert} , & ( 5 ) \\ {v}_{p 2} = {v}_{p 0} \times {v}_{p 1} , & ( 6 )\end{matrix}$$

where the complete prone view frame can then be given as {oₚ; vₚ₀, vₚ₁, vₚ₂}. As before, vₚ₀ is the view vector, vₚ₁ is the ground vector, and vₚ₂ is the up vector. An example of two corresponding endoluminal views using the flattened maps to generate the matching viewpoints is shown in FIGS. 1(a) and 1(b), which provide corresponding views obtained from a patient in a supine position and in a prone position, respectively.

The above-described embodiment provides improved visualization obtained by integrating shape-preserving flattened colons into a VC system, with use of shape-preserving flattening to obtain a flattened mesh for direct use in visual inspection of a colon surface without obstruction due to haustral folds and bends. In addition, the rendering techniques allow for use of volume rendering to generate 2D flattened images to preserve a look and feel of the traditional 3D endoluminal view, and volumetric ray-casting allows for use of other rendering techniques, such as electronic biopsy.

In addition, the flattened mesh is useful for providing a flattened colon to be used for integration into the 3D endoluminal view of a VC user interface. The flat colon is usable to guide navigation, whereby a point selected on the flattened colon is used to generate a corresponding viewpoint in the endoluminal view to immediately present a same region to the user for inspection. Correspondence between two flattened colons provides a one-to-one and onto relation, for use as intermediaries to generate corresponding viewpoints between two different scans in the endoluminal views.

In another embodiment, a method is provided for registration of a plurality of images obtained as a patient is moved between different positions, for example between a supine position and a prone position to provide a supine colon surface image and prone colon surface image, with a canonical domain being a 2D rectangle for registration of surfaces of the colon, or another organ of interest. Other examples include also a position where the patient is resting on the side. Further examples include registration of scans from different modalities, such as MRI, PET and CT, from different dates, or from before or after a drug or dye has been administered.

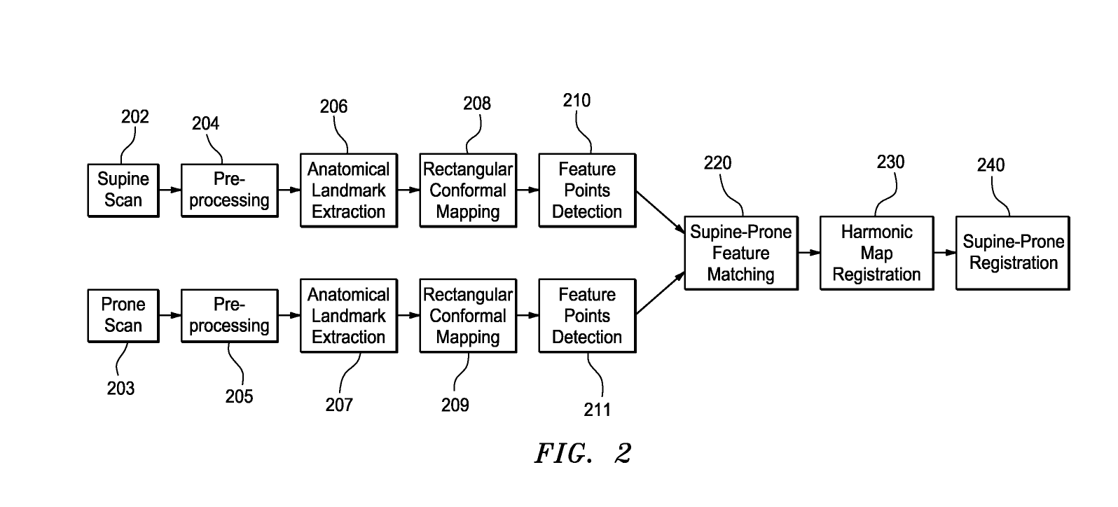

As shown in FIG. 2, the supine scan is performed in step 402 and the prone scan is performed in step 405, with each scan preferably performed to a colonography shape. Each scan can be obtained by either a Magnetic Resonance Imaging (MRI) scanner, by a CT scanner, by a confocal microscope, and the like. Images of each scan are stored and anatomical landmark extraction is performed in steps 204 and 205, respectively. The extraction is preferably based on feature extraction, either using anatomical landmarks for mapping or by geometrical mapping using identification of points of extreme curvature or high moments of gradient extremes.

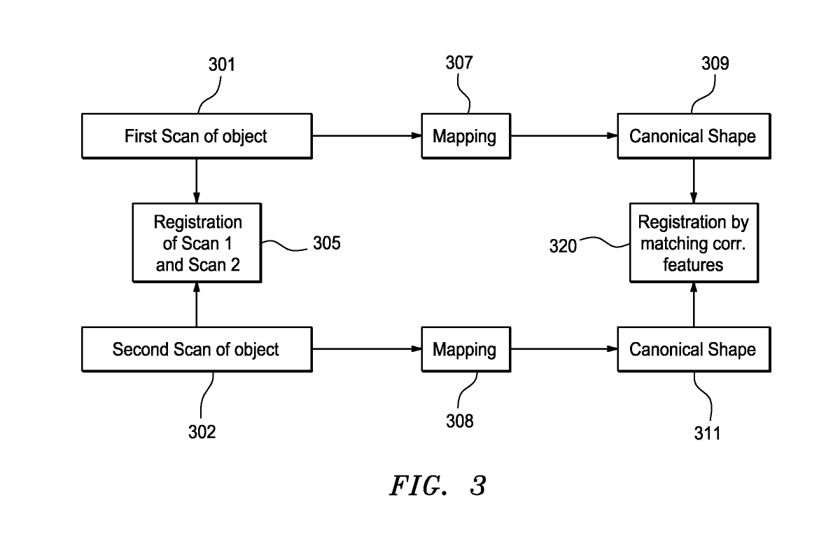

Rectangular conformal mapping, i.e. flattening, is then performed in each respective data set in steps 208 and 209. Feature points are then detected in each flattened data set in steps 210 and 212, respectively. Feature matching is then performed to correlate the data sets in step 220, followed by harmonic map registration and registration between the different position scans in steps 230 and 240, respectively. As shown in FIG. 3, an implied registration of first and second scans (301 and 302) is performed at step 305, followed by mapping the first and second scans in steps 307 and 308. Respective canonical shapes of the first and second scans are obtained in steps 309 and 311, followed by registration by matching corresponding features in step 320.

Identification of landmarks is performed to use in mapping each data set to the canonical domain. Using these landmarks, conformal geometry is used to map the surfaces from original 3D shapes to the canonical domain, which can vary depending on the object being mapped, with common domains being a unit sphere (solid or hollow) or a cylinder that can be sliced open and unrolled to form a 2D planar rectangle. According to surface uniformization theorem, a surface can be mapped according to its topology (the genus number and number of boundaries) onto one of three canonical domains (sphere, plane, or hyperbolic disk) or onto circle domains under these three geometries. Upon mapping, geometric features are identified and matched between each of the mapped surfaces. These features are used as anchor points to control the quasi-conformal relaxation of the conformal maps, for alignment of feature points, and mapping of all surfaces to the canonical domain with a one-to-one and onto correspondence, as shown in FIG. 3. This correspondence allows for efficient visualization of matching regions of scans from different patient positions.

The colon surface that is mapped onto a planar domain has elastic properties akin to a rubber membrane. The elasticity property of the colon surface is non-isotropic and can be represented as a tensor valued function defined on the whole surface, which varies from point to point. The elasticity tensor restricts the deformation pattern of the neighborhood of the point. Global flattening satisfies these local constraints determined by the elasticity tensor with harmonic registration consistent with the elasticity tensor at each point, thereby providing a geometric process for authenticating the harmonic map registration. Mapping therefore introduces stretching energy, which can be formulated rigorously by Riemannian geometry as harmonic energy. Considering all such kinds of maps, the maps that minimize the harmonic energy are selected as desired maps that also preserve angles. Such angle preserving maps from the colon surface onto the planar domain can be computed using variational algorithm, starting with an arbitrary map. Minimizing the harmonic energy allows for the angle preserving maps.

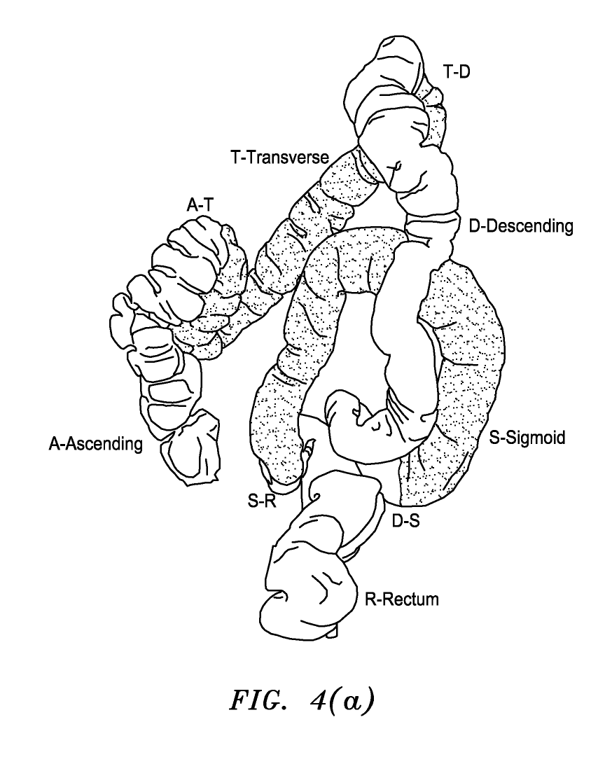

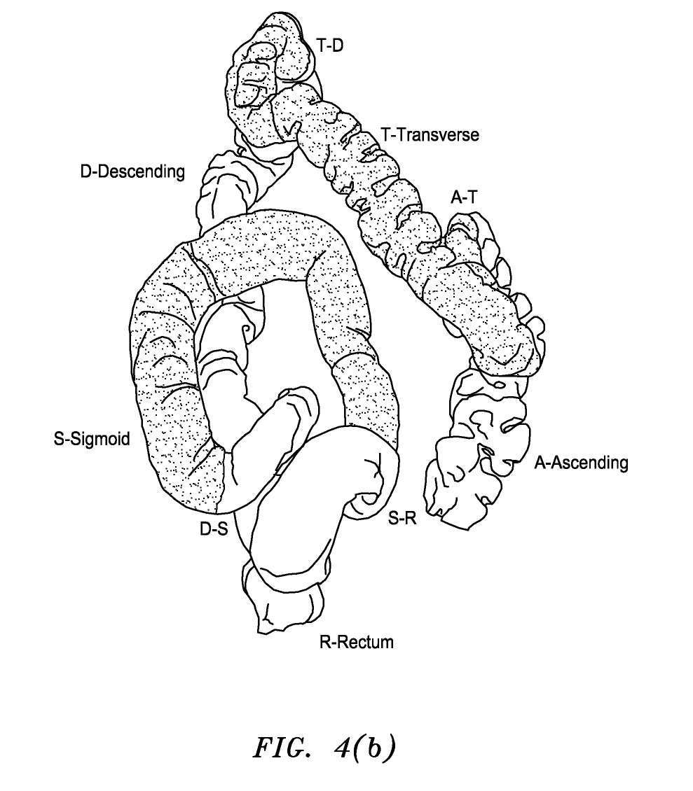

As described, the method is readily applicable to specific registration of CT colon scans acquired with the patient in both supine and prone positions. For application of supine-prone colon registration, anatomical landmarks on the organ are first identified for use in segmenting the organ into separate pieces, which can be mapped to the planar domain. For the colon, the taeniae coli and flexures are identified. The major taeniae coli is selected as the cutting line along the colon surfaces, allowing for a consistent cut. The flexures are used to slice each of mapped supine and prone colons into five segments, as shown in FIGS. 4(a) and 4(b), respectively. The five segments are preferably separately processed to reduce demand on computer resources. Since the colon is generally cylindrical in shape, slicing open the colon along the taenia coli allows for colon mapping to the 2D planar domain. This mapping is accomplished using conformal geometry, wherein local angles, and thus shapes, are preserved.

The two colon segments, for example as shown in FIGS. 4(a) and 4(b), are mapped to planes of identical size, with a one-to-one and onto mapping maintained between the data sets for two mapped positions. However, this mapping does not form a complete registration, as the structures represented by each data set do not fully align one colon view to the other colon view. To perform this full alignment, feature points are detected and matched between each the two data sets, with the feature points identified based on geometrical features, preferably on a segment-by-segment basis. For example, an encoded mean curvature image of the flattened segment of each data set is created. Using the flattened segment, the haustral folds are identified in each respective segment and matched between the different colon scans. In a preferred embodiment, the feature detection and matching are performed in the flattened 2D domain rather than the original 3D domain to reduce computational burden.

Utilizing the identified matching features for the two colon segments, the conformal mapping is adjusted to align the matching features in the planar domain for each of the colon scans to provide a mapping of a quasi-conformal map. This result provides a registration between the two scans with a one-to-one and onto mapping in the canonical domain, with the registration being a one-to-one mapping between two organs to facilitate visualization of corresponding views to the user. Matching view frustums in each original 3D domain of each data set is created by using the registered canonical domains as intermediaries. For example, the view frustum from the supine scan is mapped to a canonical representation. Once the supine and prone scans are registered in the canonical domain with a one-to-one and onto mapping, the corresponding view frustum for the prone scan, on the canonical domain, is the same. This view frustum is then mapped from the canonical domain to the original 3D domain of the prone scan, resulting in a corresponding view between the supine scan and the prone scan in their respective original 3D domains.

In regards to quasi-conformal mapping, a goal of the surface registration problem is to determine a globally optimal mapping between surfaces, which is one-to-one and onto, i.e. diffeomorphism. In the physical world, most natural deformations, which may be captured under different situations, including times, modalities, orientations, etc., are non-rigid and rarely isometric or conformal. Rather, they are quasi-conformal, as has been verified experimentally. In theory, quasi-conformal mapping is general, conformal mapping is its special case. Any mapping between two surfaces can be formulated as a diffeomorphism. In quasi-conformal geometry theory, any diffeomorphism is a quasi-conformal mapping, which can be represented by a complex function. Therefore, the mapping space between surfaces is converted to a functional space, thereby providing an efficient computational approach to manipulate mappings between surfaces. In computation, a quasi-conformal mapping can be converted to a conformal mapping under an auxiliary metric from the associated complex function.

In regards to quasi-conformal mapping for the registration application, conformal mapping of the source surface is deformed to a quasi-conformal mapping of the source surface to align with the conformal mapping of the target surface. Ricci flow is preferably used to compute quasi-conformal mappings for general topological surfaces and to handle large deformations. Ricci flow is a fundamental and powerful method, and has been employed in the proof of the Poincaré conjecture on two manifolds. Given a compact manifold with a Riemannian metric, the metric induces the curvature function. Ricci flow deforms the Riemannian metric proportionally to its Ricci curvature, such that the curvature evolves like a heat diffusion process, and eventually becomes constant everywhere. Harmonic mapping method also computes a quasi-conformal mapping by minimizing harmonic energy, but only for simply connected domains, and mainly handles deformations near isometric or conformal, and is not stable for large deformations. A more general framework is the quasi-conformal mapping method that can handle arbitrary diffeomorphic deformations.

In a preferred embodiment, conformal mapping is utilized to provide a conformal map having geometry results with minimized local area distortion while preserving local angles, thus preserving local shape characteristics of the colon surface and providing as undistorted a view of the colon anatomy.

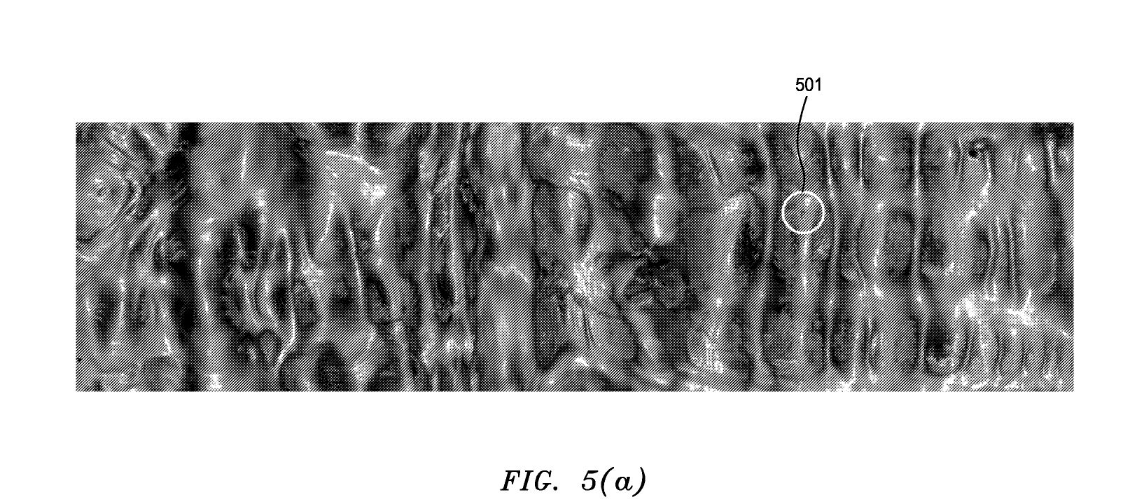

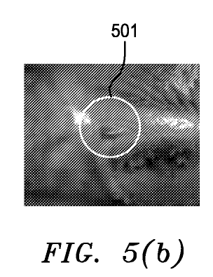

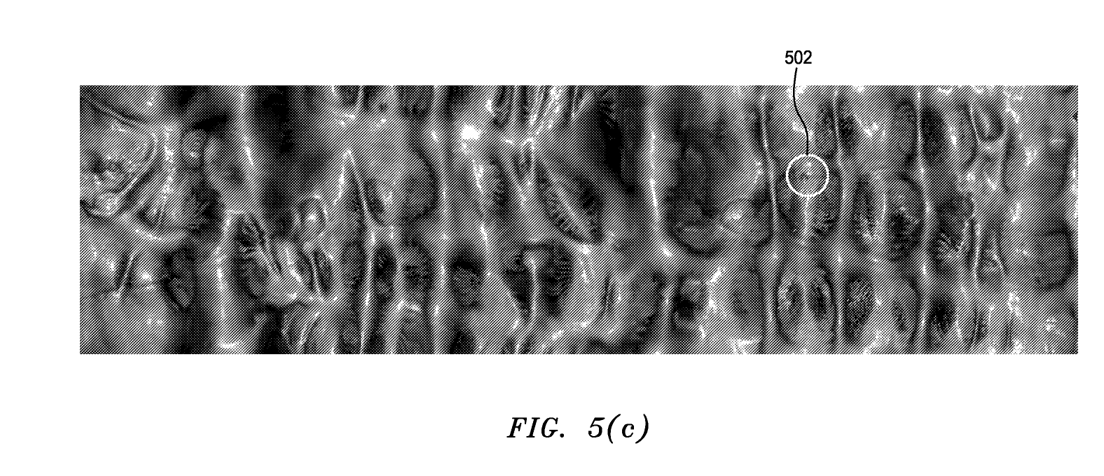

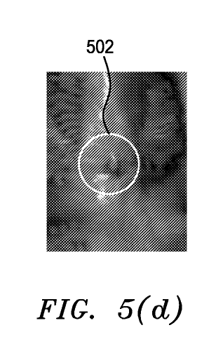

An example of results obtained from visualization of the mapped scans of the supine and prone colons are provided in FIGS. 5(a)-5(d), showing visual verification of supine-prone colon registration. FIGS. 5(a) and 5(c) are flattened views of a same surface ascending colon segment obtained via supine and prone orientations, respectively. During inspection of the surface, an anomaly 501 was observed in the supine view of FIG. 5(a), with a magnified view of anomaly 601 shown in FIG. 6(b). Landmark extraction, conformal mapping, feature point detection, feature mapping, and registration of the supine and prone scans of the colon allowed for immediate re-positioning shown in FIG. 5(c), showing the same anomaly 502 with different and more pronounced features, as shown in the magnified view of FIG. 5(d). FIGS. 1(a) and 1(b) are correlated endoluminal views from supine and prone scans obtained using the registered flattened colons.

The above-described embodiments describe application of the present invention to registration and visualization of the colon. However, the present invention is not limited to the colon and is equally applicable to visualizations used to explore lungs, brain, bladder, prostate, blood vessels and other biological organs or objects within a human or animal, as well as objects within non-biological containers, e.g. an object within a bag that is scanner by an airport scanner.

While the disclosed method has been shown and described with reference to certain exemplary embodiments thereof, it will be understood by those skilled in the art that various changes in form and details may be made therein without departing from the spirit and scope of the present invention as defined by the appended claims and equivalents thereof.

What is claimed is:

1. A method for registering scans of an object, the method comprising:
obtaining a first scan of the object from a first perspective;
obtaining a second scan of the object from a second perspective;
extracting features from within each of the first scan and the second scan;
mapping the first scan to a first canonical shape;
mapping the second scan to a second canonical shape; and
registering the first scan and the second scan by matching corresponding extracted features from the first and second canonical shapes.

2. The method of claim 1, wherein the object includes one of a colon, a brain, a bladder and a blood vessel.

3. The method of claim 1, wherein the object is a bag and the scans are obtained by a security scanner.

4. The method of claim 1, wherein the object is a biological specimen scanned with a confocal microscope.

5. The method of claim 1, wherein the features include at least one of an anatomical landmark, an object landmark, or a geometrical feature point.

6. The method of claim 1, wherein the canonical shape includes one of a rectangle, a solid sphere, a hollow sphere, a solid cuboid, and a hollow cuboid.

7. The method of claim 1, wherein a display is utilized for matching a view in the first scan to a corresponding view in the second scan.

8. A method for registering scans of a biological organ, the method comprising:
obtaining a first scan with the biological organ in a first position;
obtaining a second scan with the biological organ in a second position;
extracting anatomical landmarks from within each of the first scan and the second scan;
flattening the first scan and the second scan;
detecting feature points of each of the flattened first scan and the flattened second scan;
matching corresponding feature points from the flattened first scan and the flattened second scan; and
performing a harmonic map registration using the matched corresponding feature points.

9. The method of claim 8, wherein the first position scans a body that includes the biological organ in a supine position and the second position scans the body in a prone position.

10. The method of claim 8, wherein the first scan and the second scan are obtained at different times.

11. The method of claim 8, wherein the first scan is obtained utilizing a Magnetic Resonance Imaging (MRI) scanner and the second scan is obtained utilizing a Computed Tomography (CT) scanner.

12. The method of claim 8, wherein the first scan is obtained before administration of a drug or dye and the second scan is obtained after administration of the drug or dye.

13. The method of claim 8, wherein the feature points are detected using the extracted anatomical landmarks.

14. The method of claim 8, wherein the flattening of the first scan and the second scan comprises:
mapping each of the first scan and the second scan to a canonical shape, respectively.

15. The method of claim 8, wherein the canonical shape includes at least one of one of a rectangle, a solid sphere, a hollow sphere, a solid cuboid, and a hollow cuboid.

16. The method of claim 8, wherein the flattening includes one of rectangular conformal flattening separately performed on the scan and the second scan, shape preserving flattening with conformal geometry that preserves local shapes, and angle preserving mapping minimizing total stretching energy.

17. The method of claim 8, wherein predetermined elasticity properties for the biological organ are utilized to authenticate the harmonic map registration.

18. A system for registering scans of an object, the system comprising:
a scanner that obtains a first scan of the object from a first perspective and obtains a second scan of the object from a second perspective;
a memory for storing the first scan and the second scan; and
a processor that extracts landmarks from within each of the first scan and the second scan, flattens the first scan and the second scan, detects feature points from each of the flattened first scan and the flattened second scan, matches corresponding feature points of each of the plurality of flattened scans from the flattened first scan and the flattened second scan, and performs a harmonic map registration using the matched corresponding feature points.

19. The system of claim 18, further comprising a display for displaying the first scan and the second scan,
wherein, when an operator detects a possible anomaly in the object when observing the first scan on the display, based on the harmonic map registration, the second scan is displayed being focused on the possible anomaly observed in the first scan.
